(19) United States
(12) Patent Application Publication
(10) Pub. No.: US 2014/0043648 A1
(43) Pub. Date: Feb. 13, 2014

(54) INFORMATION PROCESSING APPARATUS, IMAGE FORMING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Makoto YOSHIMI, Kanagawa (JP)

(73) Assignee: FUJI XEROX CO., LTD., Tokyo (JP)

(21) Appl. No.: 13/868,415

(22) Filed: Apr. 23, 2013

(30) Foreign Application Priority Data
Aug. 7, 2012 (JP) 2012-175036

(51) Int. Cl. H04N 1/00

(52) U.S. Cl. CPC H04N 1/00408
USPC 358/1.15

(57) ABSTRACT

An information processing apparatus includes a first display controller, a first accepting unit, a memory, a second display controller, and a second accepting unit. The first display controller causes a display to display a setting screen in accordance with an operation performed by a user, the setting screen allowing the user to set a value of a variable in setting information. The first accepting unit accepts a change instruction to change the value of the variable included in the setting screen. The memory stores information on the accepted change instruction, in association with identification information. The second display controller causes, in response to accepting the identification information, the display to display a screen which includes an image of the setting screen which corresponds to the accepted identification information. The second accepting unit accepts a change instruction to change a value of a variable included in the corresponding setting screen.

### CROSS-REFERENCE TO RELATED APPLICATIONS

This application is based on and claims priority under 35 USC 119 from Japanese Patent Application No. 2012-175036 filed Aug. 7, 2012.

### BACKGROUND

(i) Technical Field

The present invention relates to an information processing apparatus, an image forming apparatus, an information processing method, and a non-transitory computer readable medium.

(ii) Related Art

It is known that, in an information processing apparatus, a parameter which is registered in advance is used instead of newly setting a condition of a process to be executed.

### SUMMARY

According to an aspect of the invention, there is provided an information processing apparatus including a first display controller, a first accepting unit, a memory, a second display controller, and a second accepting unit. The first display controller causes a display to display a setting screen in accordance with an operation performed by a user, the setting screen allowing the user to set a value of a variable in setting information regarding processing of the information processing apparatus. The first accepting unit accepts, while the setting screen is being displayed on the display, a change instruction to change the value of the variable included in the setting screen. The memory stores information on the change instruction accepted by the first accepting unit in the order in which the value is changed, in association with identification information. The second display controller causes, in response to accepting the identification information from the user, the display to display a screen which includes an image of the setting screen which corresponds to the accepted identification information. The second accepting unit accepts, while the corresponding setting screen is being displayed on the display, a change instruction to change a value of a variable included in the corresponding setting screen.

### BRIEF DESCRIPTION OF THE DRAWINGS

An exemplary embodiment of the present invention will be described in detail based on the following figures, wherein:

FIG. 1 is a block diagram illustrating a functional configuration of an image forming apparatus according to an exemplary embodiment of the present invention;

FIG. 2 is a block diagram illustrating a hardware configuration of the image forming apparatus;

FIG. 3 is a flowchart illustrating a process in a process registration mode;

FIG. 4 is a diagram illustrating an example of a menu screen displayed on a display;

FIG. 5 is a diagram illustrating an example of a setting screen displayed on the display;

FIG. 6 is a diagram illustrating an example of switching a setting screen in the process registration mode;

FIG. 7 is a diagram illustrating an example of process registration data;

FIGS. 8A and 8B are diagrams illustrating an example of inputting an instruction to start a process edit mode;

FIG. 9 is a flowchart illustrating a process in the process edit mode;

FIG. 10 is a diagram illustrating an example of process edit data;

FIGS. 11A to 11C are diagrams illustrating examples of a corresponding screen displayed on the display;

FIGS. 12A to 12C are diagrams illustrating an example of inputting change instructions in the process edit mode;

FIGS. 13A to 13C are diagrams illustrating an example in which process edit data is updated;

FIGS. 14A and 14B are diagrams illustrating another example of inputting a change instruction in the process edit mode;

FIG. 15 is a diagram illustrating another example in which process edit data is updated;

FIG. 16 is a diagram illustrating an example in which process registration data is updated;

FIG. 17 is a flowchart illustrating a process in which copying is performed on the basis of process registration data;

FIG. 18 is a diagram illustrating an example of process condition data;

FIG. 19 is a flowchart illustrating a process which is the assumption of generation of process registration data according to a first exemplary modification;

FIG. 20 is a diagram illustrating an example of switching a setting screen;

FIG. 21 is a diagram illustrating an example of execution process data;

FIGS. 22A and 22B are diagrams illustrating an example of generating process registration data on the basis of execution process data;

FIG. 23 is a diagram illustrating an example of process registration data generated on the basis of execution process data;

FIGS. 24A and 24B are diagrams illustrating another example of generating process registration data on the basis of execution process data;

FIGS. 25A to 25C are diagrams illustrating examples of a corresponding screen according to a second exemplary modification; and

FIG. 26 is a block diagram illustrating a functional configuration of an information processing apparatus according to a sixth exemplary modification.

### DETAILED DESCRIPTION

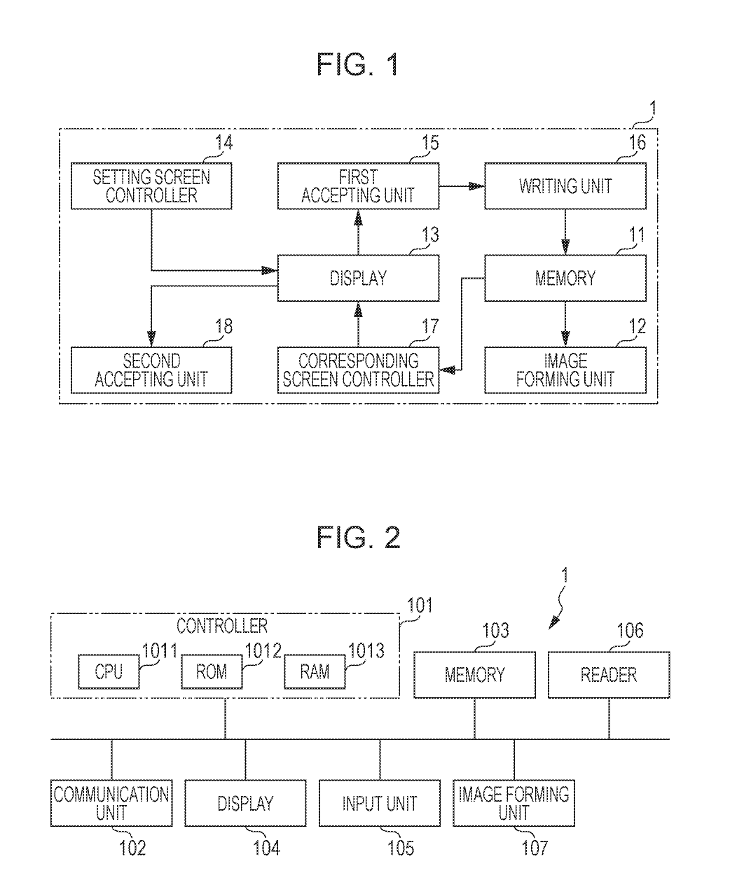

FIG. 1 is a block diagram illustrating a functional configuration of an image forming apparatus 1 according to an exemplary embodiment of the present invention. The image forming apparatus 1 (an example of an information processing apparatus) is an apparatus that functions as a copier, printer, scanner, and facsimile. The image forming apparatus 1 includes a memory 11, an image forming unit 12, a display 13, a setting screen controller 14, a first accepting unit 15, a writing unit 16, a corresponding screen controller 17, and a second accepting unit 18. The memory 11 stores values of plural variables. The image forming unit 12 forms an image on a sheet (an example of a recording medium) in accordance with values of plural variables stored in the memory 11. The display 13 displays a screen corresponding to a process performed in the image forming apparatus 1. The setting screen controller 14 (an example of a first display controller) causes the display 13 to display one setting screen among plural setting screens in accordance with an operation performed by a user. The setting screens are screens for accepting instructions to change the values of the plural variables. Each setting screen corresponds to at least one of the plural variables. The first accepting unit 15 (an example of a first accepting unit) accepts a change instruction or switch instruction from a user in a state where one setting screen among the plural setting screens is displayed on the display 13. A change instruction is an instruction to change the value of the variable corresponding to one setting screen. A switch instruction is an instruction to switch a displayed setting screen. The writing unit 16 writes one or more change instructions accepted by the first accepting unit 15 in the memory 11 in the order in which the change instructions are accepted. The writing unit 16 writes each change instruction in the memory 11 together with identification information about one setting screen which is displayed when the change instruction is accepted. The corresponding screen controller 17 (an example of a second display controller) causes the display 13 to display a corresponding screen. The corresponding screen is a screen including images corresponding to at least two setting screens which are selected in accordance with the identification information stored in the memory 11, among the plural setting screens. The second accepting unit 18 (an example of a second accepting unit) accepts a change instruction to change a value of a variable corresponding to a setting screen included in the corresponding screen in a state where the corresponding screen is displayed on the display 13.

FIG. 2 is a block diagram illustrating a hardware configuration of the image forming apparatus 1. The image forming apparatus 1 is a computer including a controller 101, a communication unit 102, a memory 103, a display 104, an input unit 105, a reader 106, and an image forming unit 107. The controller 101 controls operations of the individual units of the image forming apparatus 1. The controller 101 includes a central processing unit (CPU) 1011, a read only memory (ROM) 1012, and a random access memory (RAM) 1013. The CPU 1011 is a control device that executes a program and thereby controls the individual units of the image forming apparatus 1. The ROM 1012 is a nonvolatile storage device that stores various programs and data. The RAM 1013 is a volatile storage device that stores data. The communication unit 102 communicates with an external apparatus via a communication line, such as a local area network (LAN) or a telephone line. The memory 103 is a storage device that stores data and programs, for example, a hard disk drive (HDD). The display 104 includes a display device, such as a liquid crystal display or an organic electroluminescence (EL) display, and displays a menu screen used for operating the image forming apparatus 1 or various messages. The display 104 also includes a touch screen (touch panel) which is superposed on a display. The input unit 105 includes various keys used for inputting data or instructions to the image forming apparatus 1. A user operates the display 104 or the input unit 105, thereby inputting various instructions to the image forming apparatus 1.

The reader 106 is an image scanner that optically reads a document and generates image data from the read document. Hereinafter, generating image data from a read document is referred to as “scan”. The reader 106 performs scan in accordance with the values of various variables related to the conditions of scan stored in the memory 103. The variables related to the conditions of scan include, for example, resolution, a format of image data, 1-sided scan or 2-sided scan, color scan or monochrome scan, and so forth. The image forming unit 107 forms an image on a sheet using, for example, an electrophotographic system or an inkjet system. Hereinafter, forming an image on a sheet is referred to as “output”. The image forming unit 107 performs output in accordance with the values of various variables related to the conditions of output stored in the memory 103. The variables related to the conditions of output include, for example, magnification, 1-sided output or 2-sided output, the number of copies, color output or monochrome output, and so forth.

In the image forming apparatus 1, the CPU 1011 is an example of the setting screen controller 14, the first accepting unit 15, the writing unit 16, the corresponding screen controller 17, and the second accepting unit 18. The ROM 1012, the RAM 1013, and the memory 103 correspond to an example of the memory 11. The memory 103 is an example of a first memory region, and the RAM 1013 is an example of a second memory region. The display 104 is an example of the display 13. The image forming unit 107 controlled by the CPU 1011 is an example of the image forming unit 12.

In the image forming apparatus 1, various variables related to the conditions of scan or output have initial values which are preset. The initial values are stored in the memory 103. The values of the various variables are changed in a process registration mode or a process edit mode. The process registration mode is a mode in which a user newly registers a change of the value of a variable. The process registration mode is executed by operating a setting screen by the user. The process edit mode is a mode in which the user further changes the value of a variable which has been changed in the process registration mode. The process edit mode is executed by operating a corresponding screen by the user. Hereinafter, processes in the process registration mode and the process edit mode will be descried in detail.

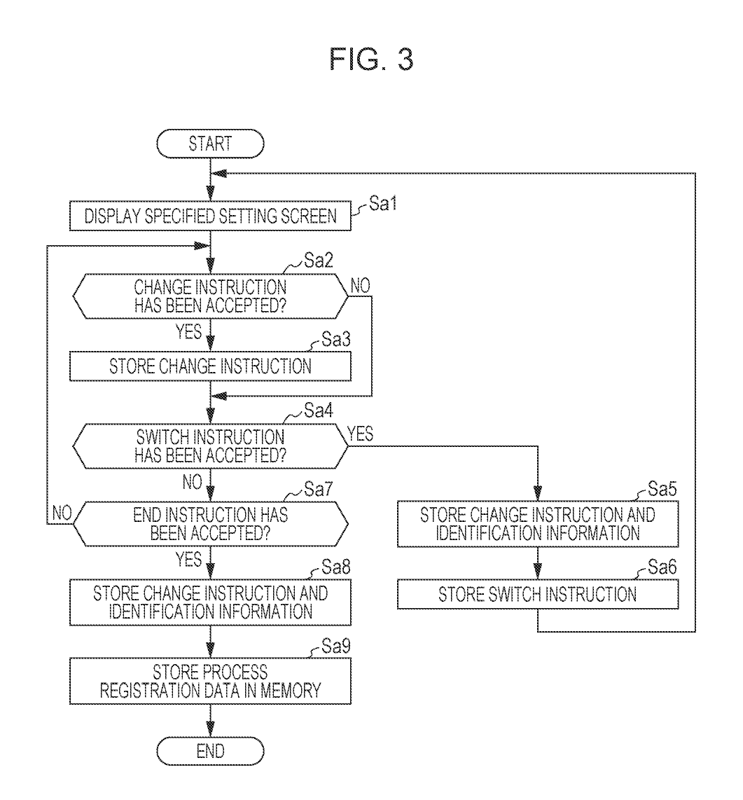

FIG. 3 is a flowchart illustrating a process in the process registration mode. The process illustrated in FIG. 3 is started upon an instruction to start the process registration mode being input to the image forming apparatus 1 by a user. The instruction to start the process registration mode is provided by, for example, operating a key provided in the input unit 105 or operating a button displayed on the display 104. Upon the instruction to start the process registration mode being input, the CPU 1011 displays a menu screen on the display 104. The menu screen allows a user to select a function for which a change of the value of a variable is to be registered, from among the various functions of the image forming apparatus 1 (copy, print, scan, facsimile, etc.).

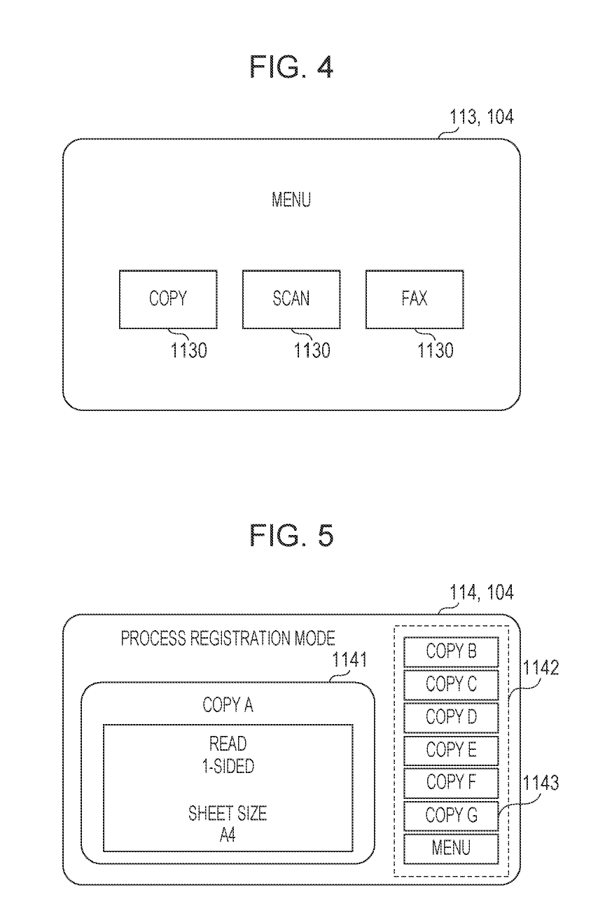

FIG. 4 is a diagram illustrating an example of a menu screen 113 displayed on the display 104. The menu screen 113 includes menu buttons 1130 representing the functions of copy, scan, and facsimile. The user presses any one of the plural menu buttons 1130 displayed on the menu screen 113, thereby selecting a function for which a change of the value of a variable is to be registered. In FIG. 4, pressing of any one of the menu buttons 1130 by the user corresponds to input of a switch instruction. A switch instruction for the menu screen 113 is an instruction to switch the displayed menu screen 113 to a setting screen.

Referring back to FIG. 3, in step Sa1, the CPU 1011 displays a setting screen specified by a switch instruction on the display 104. The identification information about the setting screen specified by the switch instruction is stored in the RAM 1013. The CPU 1011 reads out the identification information from the RAM 1013, and displays the setting screen corresponding to the identification information. In a state where the setting screen is displayed, the user inputs a change instruction or a switch instruction. Input of a change instruction is accepted before a switch instruction is input.

FIG. 5 is a diagram illustrating an example of a setting screen 114 displayed on the display 104. The setting screen 114 includes a first display region 1141 and a second display region 1142. The first display region 1141 is a region for accepting input of a change instruction. In the first display region 1141, at least one of various variables is displayed. A change instruction is input by a user by touching a variable displayed in the first display region 1141. Specifically, when the user touches a variable displayed in the first display region 1141, plural options related to the value of the variable are displayed in the first display region 1141. The user inputs a change instruction by touching one of the plural options.

The setting screen 114 illustrated in FIG. 5 is a setting screen related to the copy function of the image forming apparatus 1. In this example, the setting screen 114 is identified by the identification information “copy A” which is displayed in the first display region 1141. In the first display region 1141, it is displayed that a variable indicating the setting of reading a document has a value “1-sided”. If the user touches the region in which “1-sided” is displayed, the value of the variable indicating the setting of reading a document is changed, for example, from “1-sided” to “2-sided”. Also, in the first display region 1141, it is displayed that a variable indicating the setting of a sheet size has a value “A4”. If the user touches the region in which “A4” is displayed, the value of the variable indicating the setting of a sheet size is changed, for example, from “A4” to “A3”.

The second display region 1142 is a region for accepting input of a switch instruction. In the second display region 1142, switch buttons 1143 are displayed. Each switch button 1143 is a button for switching one setting screen 114 displayed on the display 104 to another setting screen 114. A switch instruction is input by a user by pressing the switch button 1143. In the second display region 1142 of the setting screen 114 illustrated in FIG. 5, the switch buttons 1143 for “copy B” to “copy G” and “menu” are displayed. For example, pressing of the switch button 1143 for “copy B” by a user corresponds to inputting an instruction to switch the setting screen 114 identified by the identification information “copy A” to the setting screen 114 identified by the identification information “copy B”.

Referring back to FIG. 3, in step Sa2, the CPU 1011 determines whether or not input of a change instruction has been accepted. If it is determined that input of a change instruction has been accepted (YES in step Sa2), the CPU 1011 proceeds to step Sa3. If it is determined that input of a change instruction has not been accepted (NO in step Sa2), the CPU 1011 proceeds to step Sa4.

In step Sa3, the CPU 1011 stores the change instruction in the RAM 1013. In step Sa4, the CPU 1011 determines whether or not input of a switch instruction has been accepted. If it is determined that input of a switch instruction has been accepted (YES in step Sa4), the CPU 1011 proceeds to step Sa5. If it is determined that input of a switch instruction has not been accepted (NO in step Sa4), the CPU 1011 proceeds to step Sa7.

In step Sa5, the CPU 1011 writes the change instruction in a process registration memory together with identification information. The process registration memory is a region in the RAM 1013, and stores change instructions in association with respective pieces of identification information. In the process registration memory, plural sets of a change instruction and a corresponding piece of identification information are stored in the order in which the change instructions have been accepted. The CPU 1011 writes the change instruction stored in the RAM 1013 in the process registration memory together with the identification information about the setting screen 114 displayed on the display 104. After the change instruction and the identification information have been written in the process registration memory, the CPU 1011 erases the change instruction stored in the RAM 1013. If no change instructions are stored in the RAM 1013 (if no change instructions have been input), the CPU 1011 writes the identification information about the setting screen 114 displayed on the display 104 and an empty change instruction in the process registration memory. In step Sa6, the CPU 1011 stores the switch instruction in the RAM 1013. Specifically, the CPU 1011 stores, in the RAM 1013, the identification information about the setting screen 114 which has been specified by the switch instruction. In a case where the user presses any one of the plural menu buttons 1130 of the menu screen 113, the CPU 1011 stores, in the RAM 1013, a predetermined piece of identification information among the pieces of identification information about the plural setting screens 114 related to the function indicated by the pressed menu button 1130.

In step Sa7, the CPU 1011 determines whether or not input of an end instruction has been accepted. An end instruction in the process registration mode is an instruction to end the process registration mode. An end instruction in the process registration mode is input, for example, by a user by pressing an end button provided in the input unit 105. Alternatively, an end instruction in the process registration mode may be input by operating a button displayed on the display 104. If it is determined that input of an end instruction has been accepted (YES in step Sa7), the CPU 1011 proceeds to step Sa8. If it is determined that input of an end instruction has not been accepted (NO in step Sa7), the CPU 1011 returns to step Sa2.

In step Sa8, the CPU 1011 writes the change instruction in the process registration memory together with the identification information. The process in step Sa8 is similar to that in step Sa5. In step Sa9, the CPU 1011 writes the data stored in the process registration memory (hereinafter referred to as process registration data) in the memory 103. After the process registration data has been written in the memory 103, the CPU 1011 erases the process registration data stored in the process registration memory. With the above-described process, the CPU 1011 generates process registration data and writes the process registration data in the memory 103, in accordance with operations performed by the user. When the user operates the display 104 or the input unit 105 to provide an instruction to start a process based on the process registration data, the reader 106 or the image forming unit 107 performs scan or output under the condition based on the process registration data.

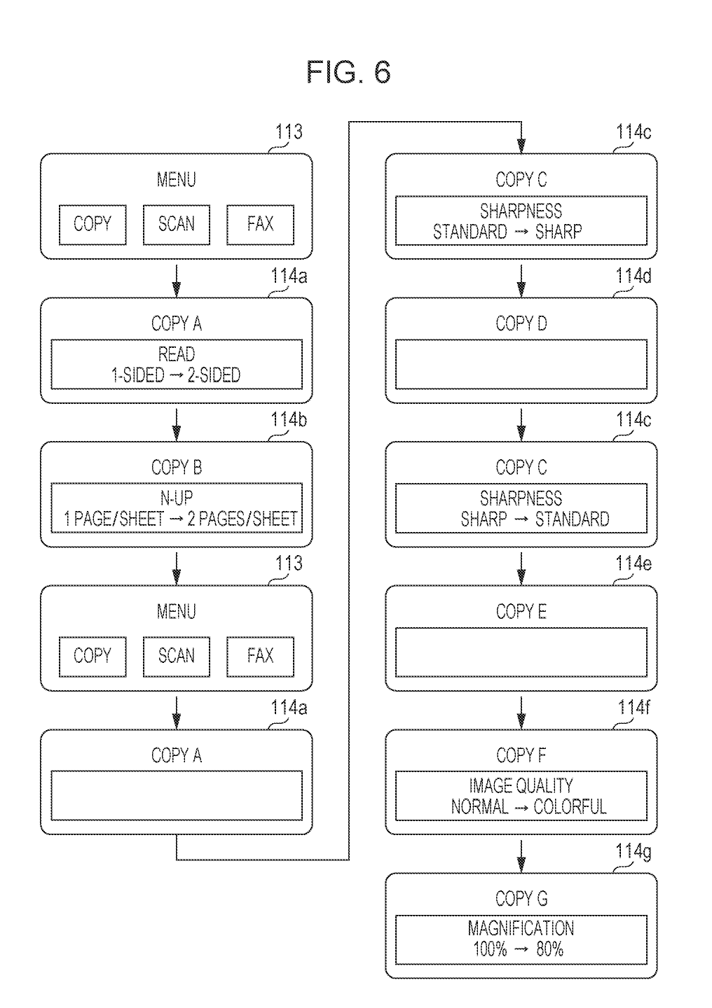

FIG. 6 is a diagram illustrating an example of switching the setting screen 114 in the process registration mode. FIG. 6 illustrates a state where the first display region 1141 of the setting screen 114 is switched. Illustration of a state where the second display region 1142 is switched is omitted. Upon the process registration mode being started, the menu screen 113 is displayed on the display 104. FIG. 6 illustrates an example in which the user selects “copy” as a function for which a change of the value of a variable is to be registered. When the user selects “copy” on the menu screen 113, the identification information “copy A” is stored in the RAM 1013. As a result, a setting screen 114a identified by the identification information “copy A” is displayed on the display 104. Hereinafter, a lower-case alphabetic character corresponding to an upper-case alphabetic character included in identification information is attached at the end of “setting screen 114”, for example, “setting screen 114a”, and thereby plural setting screens are distinguished from one another.

In the example illustrated in FIG. 6, the setting screen 114 is sequentially switched from the setting screen 114a to the setting screen 114g in the order indicated by arrows in response to switch instructions provided by the user. In this example, the setting screen 114a and the setting screen 114c are displayed twice. Also, in the example illustrated in FIG. 6, the menu screen 113 is displayed again at the transition of the setting screen 114. On the setting screens 114a (first), 114b, 114c, 114f, and 114g among the setting screens 114a to 114g, the user inputs a change instruction before inputting a switch instruction. On the other hand, on the setting screens 114a (second), 114d, and 114e, the user inputs a switch instruction without inputting a change instruction. In FIG. 6, illustration of a variable for which a change instruction has not been input among the variables displayed in the first display region 1141 is omitted.

On the setting screen 114a which is displayed first, the user inputs a change instruction to change the value of the variable indicating the setting of reading a document from “1-sided” to “2-sided”. After inputting the change instruction, the user presses the switch button 1143 for “copy B” to input a switch instruction. Upon the switch button 1143 for “copy B” being pressed, the setting screen 114 is switched from the setting screen 114a to the setting screen 114b.

The user also inputs change instructions on the setting screens 114b, 114c, 114f, and 114g. On the setting screen 114b, the user inputs a change instruction to change the value of the variable indicating the setting of N-up (collectively printing the images of plural pages on one sheet) from “1 page/sheet” to “2 pages/sheet”. “1 page/sheet” means that the image of one page is formed on one sheet. “2 pages/sheet” means that the images of two pages are formed on one sheet. On the setting screen 114c which is displayed first, the user inputs a change instruction to change the value of the variable indicating the setting of sharpness from “standard” to “sharp”. On the setting screen 114c which is displayed second, the user inputs a change instruction to change the value of the variable indicating the setting of sharpness from “sharp” to “standard”. That is, on the setting screen 114c which is displayed second, the user changes the value of the variable indicating the setting of sharpness to “standard”, which is the value before the process registration mode is started (initial value). On the setting screen 114f, the user inputs a change instruction to change the value of the variable indicating the setting of image quality from “normal” to “colorful”. On the setting screen 114g, the user inputs a change instruction to change the value of the variable indicating the setting of magnification from “100%” to “80%”.

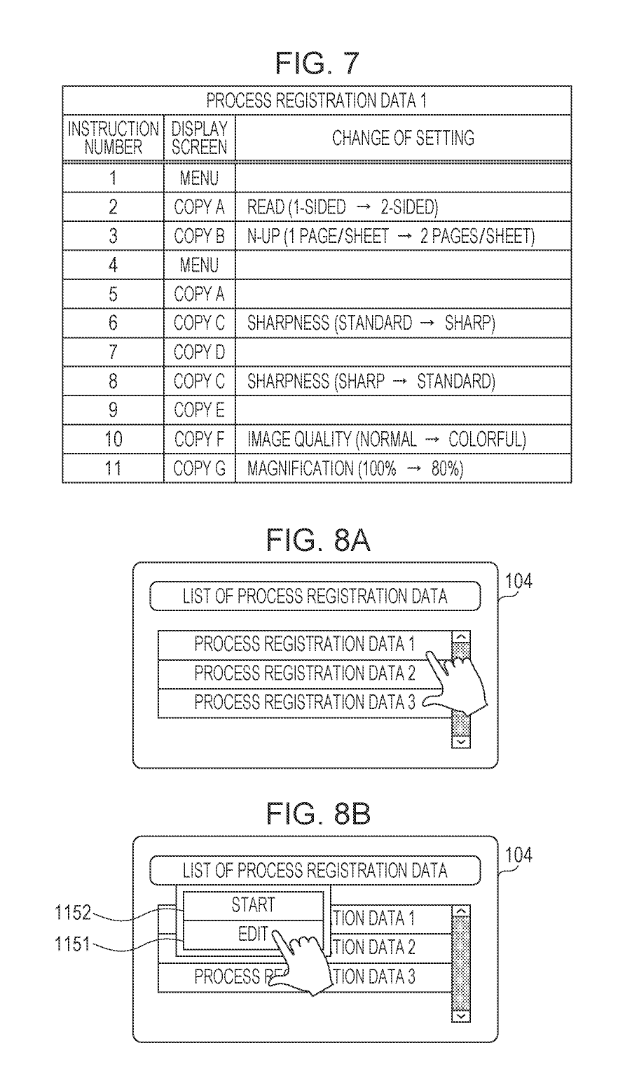

FIG. 7 is a diagram illustrating an example of the process registration data written in the memory 103. FIG. 7 illustrates the process registration data in a case where change instructions and switch instructions are input in the order illustrated in FIG. 6. “Instruction number” is a number for identifying a switch instruction accepted by the CPU 1011. “Display screen” indicates the identification information about the setting screen 114 or the menu screen 113 which is displayed when input of a switch instruction is accepted. “Change of setting” indicates a change instruction accepted before a switch instruction is input. As described above, the user inputs change instructions on the setting screens 114a (first), 114b, 114c, 114f, and 114g. Thus, in the rows corresponding to the instruction numbers “2”, “3”, “6”, “8”, “10”, and “11”, the content of a change instruction is stored in the column “change of setting”. On the other hand, the user inputs no change instructions on the setting screens 114a (second), 114d, and 114e. Thus, in the rows corresponding to the instruction numbers “1”, “4”, “5”, “7”, and “9”, no content of a change instruction is stored in the column “change of setting”.

Now, it is assumed that the user registers a change of the value of a variable by mistake in the process registration mode, or that the user wants to further change the value of a variable which has been changed in the process registration mode. In this case, it is necessary for the user to start the process registration mode again and register a change of the value of a variable again. Also, it is necessary for the user to search again for the setting screen 114 corresponding to the variable for which registration has been performed by mistake or the variable for which registration is to be changed, among the plural setting screens 114. Accordingly, in an exemplary embodiment of the present invention, a process in the process edit mode described below is performed.

FIGS. 8A and 8B are diagrams illustrating an example in which the user inputs an instruction to start the process edit mode. To start the process edit mode, the user operates the display 104 to display a list of process registration data. The list of process registration data is a list of process registration data which has been written in the memory 103 in the process registration mode, and is generated for each user, for example. An instruction to start the process edit mode is provided by selecting, by the user, a piece of process registration data on which edit is to be performed from among the pieces of process registration data included in the list. In FIG. 8A, the list of process registration data includes “process registration data 1” to “process registration data 3”, and the user selects “process registration data 1”. Upon the process registration data being selected by the user, the CPU 1011 displays an edit button 1151 and a start button 1152 on the display 104, as illustrated in FIG. 8B. The edit button 1151 is a button for starting the process edit mode. The start button 1152 is a button for starting a process based on the process registration data. The process edit mode is started upon pressing of the edit button 1151 by the user. On the other hand, a process based on the process registration data is started upon pressing of the start button 1152 by the user. The process based on the process registration data will be described below.

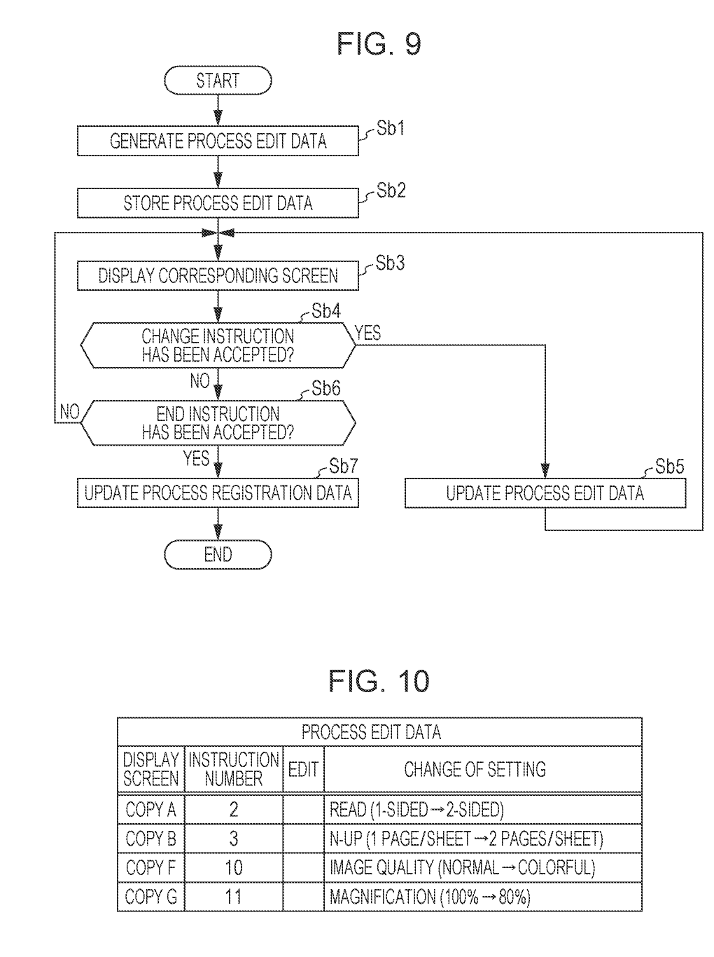

FIG. 9 is a flowchart illustrating a process in the process edit mode. In step Sb1, the CPU 1011 generates process edit data. Process edit data is based on process registration data, and serves as a base for displaying a corresponding screen. The CPU 1011 reads out a piece of process registration data selected by the user from among the pieces of process registration data stored in the memory 103, and generates process edit data.

FIG. 10 is a diagram illustrating an example of process edit data. “Instruction number”, “display screen”, and “change of setting” in the process edit data correspond to “instruction number”, “display screen”, and “change of setting” in the process registration data. “Edit” indicates whether or not the value of a variable has been changed in the process edit mode. The column of “edit” is empty in an initial state, and “YES” is written therein upon the value of a variable being changed in the process edit mode. Process edit data is generated as a result of performing the following processes on process registration data by the CPU 1011.

(A) In process registration data, a row in which a change instruction is not stored in the column of “change of setting” is deleted.

(B) In a case where a change instruction has been input plural times for the same variable and where the variable is initialized by the last change instruction, the rows of the change instructions corresponding to the variable are deleted.

The process edit data illustrated in FIG. 10 is process edit data which is generated on the basis of the process registration data illustrated in FIG. 7. If the process (A) is performed on the process registration data illustrated in FIG. 7, the rows corresponding to the instruction numbers “1”, “4”, “5”, “7”, and “9” are deleted. If the process (B) is performed, the rows corresponding to the instruction numbers “6” and “8” are deleted.

Referring back to FIG. 9, in step Sb2, the CPU 1011 stores the process edit data in the RAM 1013. In step Sb3, the CPU 1011 displays a corresponding screen. The CPU 1011 reads out the process edit data from the RAM 1013, and displays a corresponding screen on the display 104.

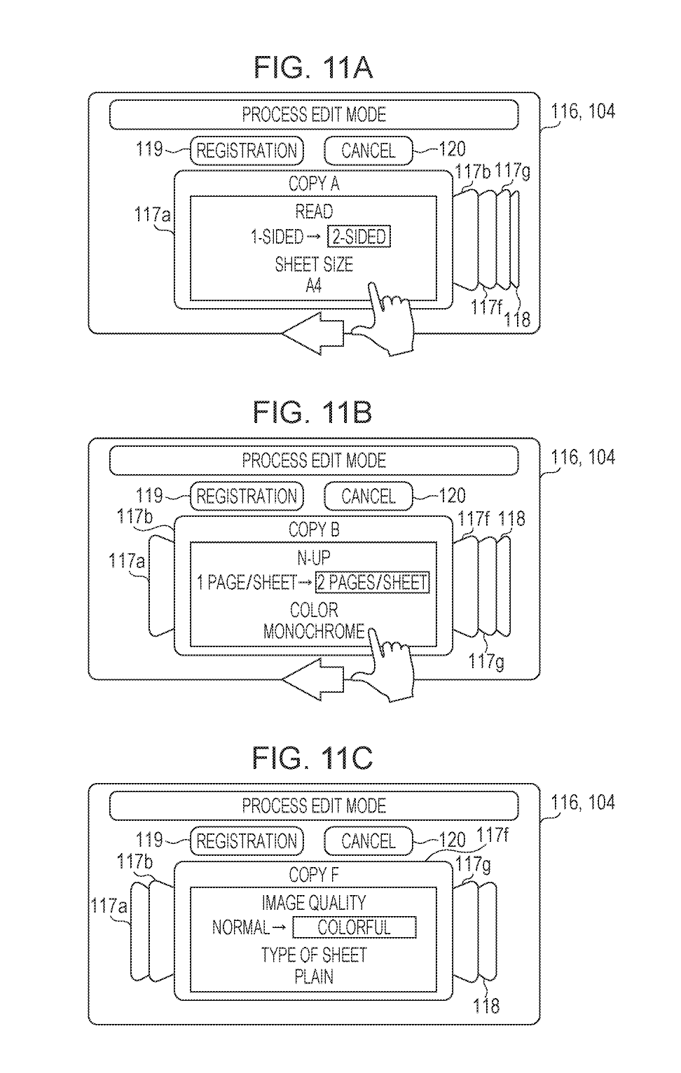

FIGS. 11A to 11C are diagrams illustrating examples of a corresponding screen 116 displayed on the display 104. The corresponding screen 116 includes plural corresponding images 117, a menu image 118, a registration button 119, and a cancel button 120. Each corresponding image 117 corresponds to a setting screen 114, and is generated by reducing the first display region 1141 of the setting screen 114. Each corresponding image 117 shows a variable, and accepts a change instruction. The menu image 118 accepts a switch instruction. The registration button 119 is a button for registering a change of the value of a variable in the process edit mode. The cancel button 120 is a button for cancelling a change of the value of a variable.

The corresponding images 117 are displayed on the basis of the information about “display screen” in the process edit data. In FIGS. 11A to 11C, the plural corresponding images 117a, 117b, 117f, and 117g included in the corresponding screen 116 correspond to the first display regions 1141 of the setting screens 114a, 114b, 114f, and 114g. The corresponding images 117 are displayed in ascending order of the instruction number in the process edit data. In FIGS. 11A to 11C, the corresponding images 117 are displayed using a so-called cover flow scheme. One corresponding image 117 is displayed with a larger size than the other corresponding images 117 whose position based on the instruction number is before or after the one corresponding image 117. Hereinafter, the corresponding image 117 which is displayed with a larger size than the other corresponding images 117 will be referred to as a “target image”. In the examples illustrated in FIGS. 11A to 11C, the target images are the corresponding images 117a, 117b, and 117f, respectively. The target image is switched in the order illustrated in FIGS. 11A to 11C when the user moves his/her finger in the direction indicated by the arrow with the finger being in contact with the target image. On the other hand, if the user moves the finger in the direction opposite to the arrow, the target image is switched in the reverse order of the order illustrated in FIGS. 11A to 11C. In this way, one of the corresponding images 117 is selected as a target image by an operation performed by the user.

In the corresponding image 117, a variable whose value has been changed in response to a change instruction in the process registration mode is displayed so as to be distinguished from the other variables whose value has not been changed. For example, in the example illustrated in FIG. 11A, the user has changed the value of the variable indicating the setting of reading a document from “1-sided” to “2-sided” in the process registration mode, and thus “2-sided” is surrounded by a rectangle so as to be distinguished from the other variables. Also, “2 pages/sheet” in FIG. 11B and “colorful” in FIG. 11C are the values of variables which have been changed in the process registration mode, like “2-sided”, and are thus surrounded by rectangles so as to be distinguished from the other variables.

Referring back to FIG. 9, in step Sb4, the CPU 1011 determines whether or not input of a change instruction has been accepted. If it is determined that input of a change instruction has been accepted (YES in step Sb4), the CPU 1011 proceeds to step Sb5. If it is determined that input of a change instruction has not been accepted (NO in step Sb4), the CPU 1011 proceeds to step Sb6.

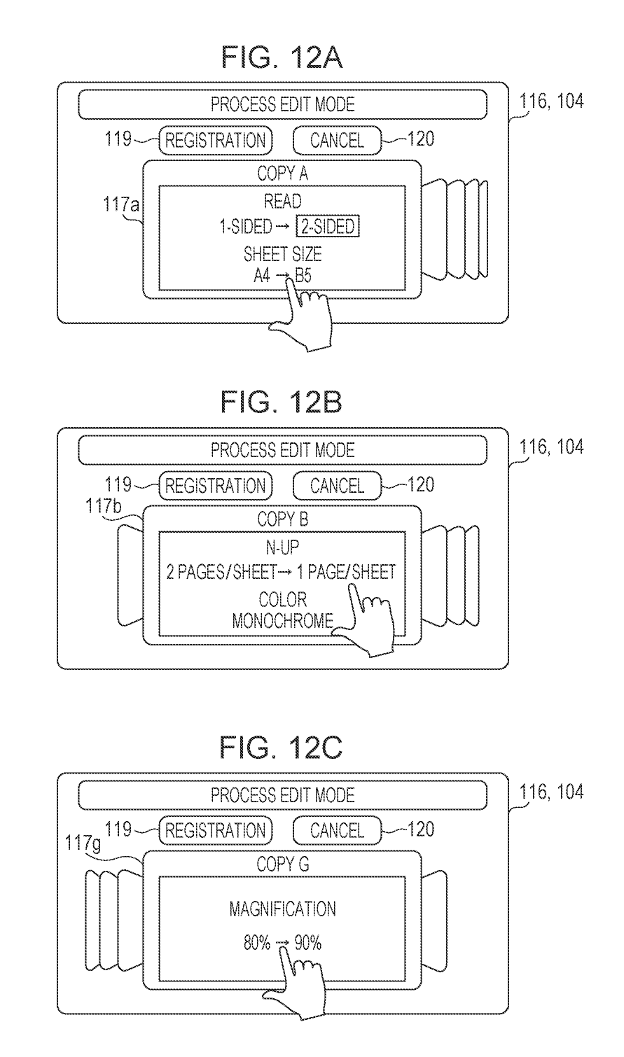

FIGS. 12A to 12C are diagrams illustrating an example in which the user inputs change instructions in the process edit mode. In the process edit mode, as in the process registration mode, a change instruction is input by the user by touching a variable displayed on the corresponding screen 116. In FIG. 12A, the user inputs a change instruction to change the value of the variable indicating the setting of the sheet size from “A4” to “B5”. In FIG. 12B, the user inputs a change instruction to change the value of the variable indicating the setting of N-up from “2 pages/sheet” to “1 page/sheet”. In FIG. 12C, the user inputs a change instruction to change the value of the variable indicating the setting of magnification from “80%” to “90%”.

Referring back to FIG. 9, in step Sb5, the CPU 1011 updates the process edit data. The CPU 1011 updates the process edit data in accordance with the change instruction accepted in step Sb4.

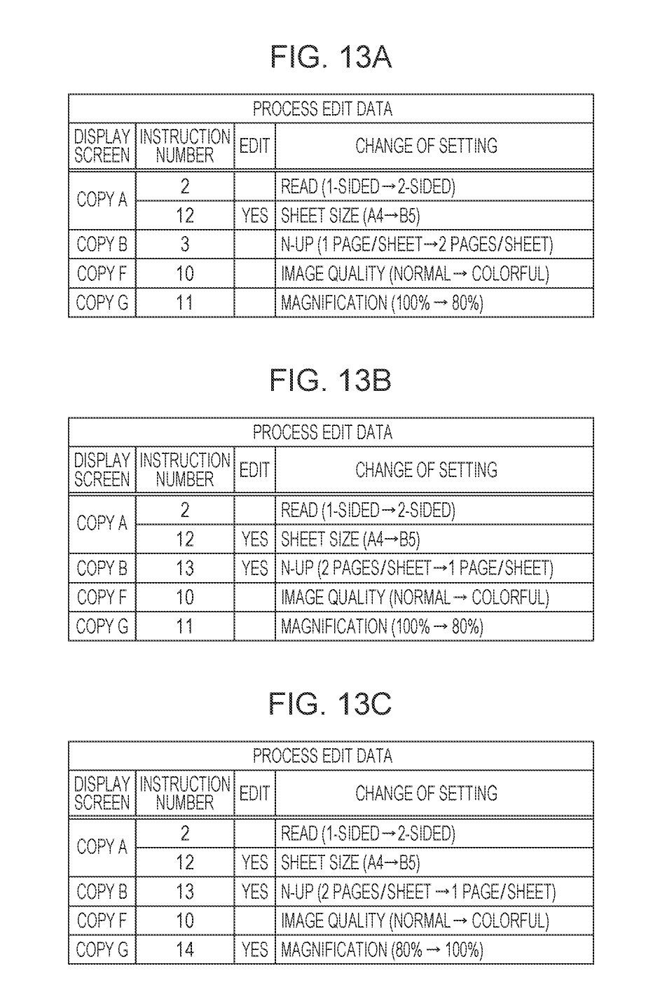

FIGS. 13A to 13C are diagrams illustrating examples in which the process edit data is updated. The process edit data is updated by performing the following processes by the CPU 1011.

(C) Regarding a variable for which a change instruction has been newly input, if the previous change instruction is included in the process edit data, the process edit data is overwritten with the newly input change instruction.

(D) Regarding a variable for which a change instruction has been newly input, if the previous change instruction is not included in the process edit data, a new row is generated in the column of “display screen” indicating the identification information about he setting screen 114 corresponding to the corresponding image 117 to which the change instruction has been newly input, and the newly input change instruction is written therein.

(E) “YES” is written in the column of “edit” in the row on which the process (C) or (D) has been performed.

(F) The next number of the largest number among the instruction numbers included in the process edit data is written in the column of “instruction number” in the row on which the process (C) or (D) has been performed.

FIGS. 13A to 13C respectively illustrate examples in which the process edit data illustrated in FIG. 10 is updated in a case where the change instructions illustrated in FIGS. 12A to 12C have been sequentially input. Regarding FIG. 12A, the previous change instruction about the variable indicating the setting of the sheet size is not included in the process edit data illustrated in FIG. 10. Thus, in FIG. 12A, upon a change instruction to change the value of the variable indicating the setting of the sheet size from “A4” to “B5” being input, a new row for storing the change instruction is generated in the process (D), as illustrated in FIG. 13A. Regarding FIGS. 12B and 12C, the previous change instruction about the variable indicating the setting of N-up, or the previous change instruction about the variable indicating the setting of magnification is included in the process edit data illustrated in FIG. 10. Thus, in FIG. 12B, upon a change instruction to change the value of the variable indicating the setting of N-up from “2 pages/sheet” to “1 page/sheet” being input, the change instruction replaces the previous change instruction in the process (C), as illustrated in FIG. 13B. In FIG. 12C, upon a change instruction to change the value of the variable indicating the setting of magnification from “80%” to “90%” being input, the change instruction replaces the previous change instruction in the process (C), as illustrated in FIG. 13C. Also, in the process (E), “YES” is written in the column “edit” in the rows updated in the process illustrated in FIGS. 13A to 13C. Furthermore, in the process (F), “12”, “13”, and “14” are written in the column “instruction number” in the rows updated in the process illustrated in FIGS. 13A to 13C.

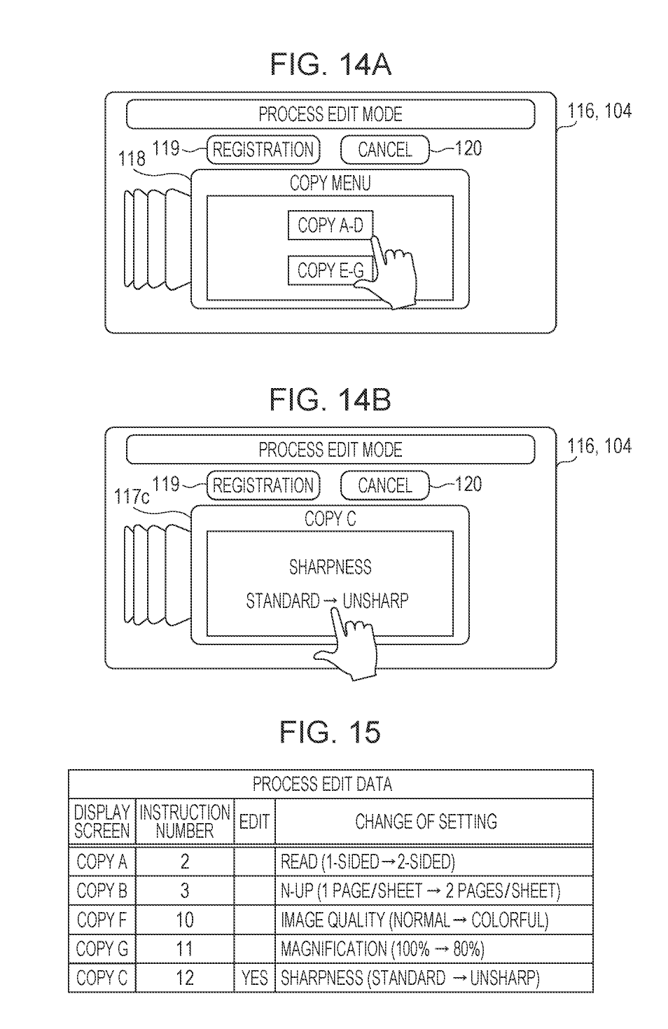

FIGS. 14A and 14B are diagrams illustrating another example in which the user inputs a change instruction in the process edit mode. The user operates the menu image 118 in FIG. 14A to display the corresponding image 117c on the corresponding screen 116, as illustrated in FIG. 14B. The corresponding image 117c corresponds to the setting screen 114c (FIG. 6). In FIG. 14B, the user inputs a change instruction to change the value of the variable indicating the setting of sharpness from “standard” to “unsharp”. In this way, the variable edited by the user in the process edit mode is not always the variable corresponding to the setting screen 114 indicated in the column “display screen” in the process edit data.

FIG. 15 is a diagram illustrating another example in which the process edit data is updated. FIG. 15 illustrates an example in which the process edit data illustrated in FIG. 10 is updated when the change instruction illustrated in FIG. 14B is input. In the process D, if the process edit data does not include the column “display screen” showing the identification information about the setting screen 114 corresponding to the corresponding image 117 to which a change instruction has been newly input, the CPU 1011 generates a new row for the identification information, and writes the newly input change instruction therein. In the example illustrated in FIG. 15, the process edit data illustrated in FIG. 10 does not include the column “display screen” for “copy C”, and thus, upon a change instruction being input to the corresponding image 117c illustrated in FIG. 14B, a new row for “copy C” is generated.

Referring back to FIG. 9, in step Sb6, the CPU 1011 determines whether or not input of an end instruction has been accepted. An end instruction in the process edit mode is an instruction to end the process edit mode. An end instruction in the process edit mode is input by the user by pressing the registration button 119. If it is determined that input of an end instruction has been accepted (YES in step Sb6), the CPU 1011 proceeds to step Sb7. If it is determined that input of an end instruction has not been accepted (NO in step Sb6), the CPU 1011 returns to step Sb3.

In step Sb7, the CPU 1011 updates the process registration data. The CPU 1011 updates the process registration data on the basis of the process edit data stored in the RAM 1013.

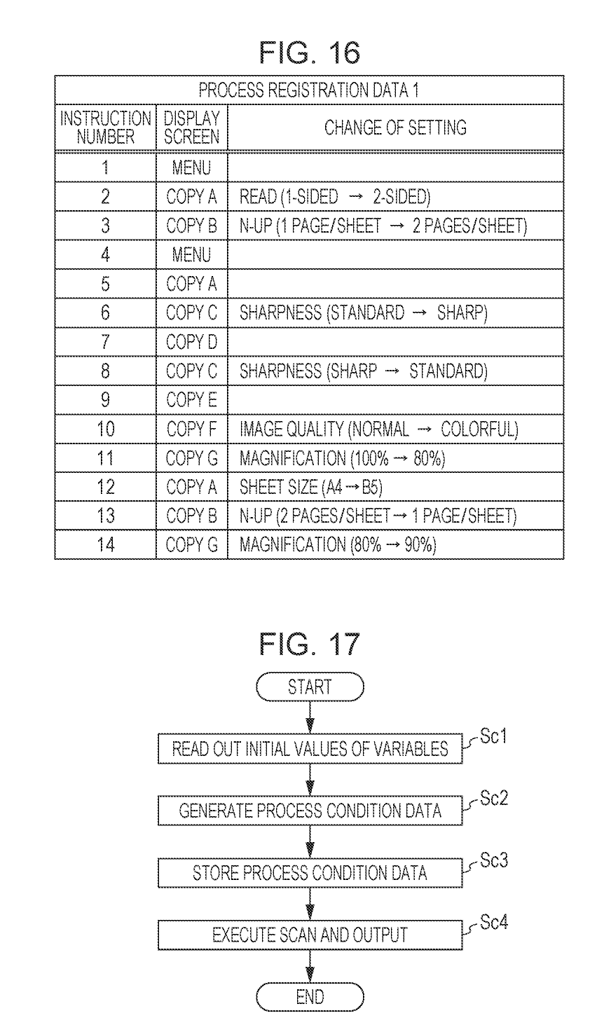

FIG. 16 is a diagram illustrating an example in which the process registration data is updated. FIG. 16 illustrates an example in which the process registration data illustrated in FIG. 7 is updated on the basis of the process edit data illustrated in FIG. 13C. The process registration data is updated by adding, to the process registration data, information in the rows in which “YES” is written in the column “edit” in the process edit data. In the example illustrated in FIG. 16, the rows corresponding to the instruction numbers “12”, “13”, and “14” are newly added to the process registration data.

With the above-described process, the values of variables which have been changed in the process registration mode are further changed in the process edit mode. This suppresses the occurrence of the necessity for starting the process registration mode again and registering a change of the value of a variable again when the user wants to change the registration which has been performed in the process registration mode. Also, in the process edit mode, the corresponding image 117 corresponding to the setting screen 114 to which a change instruction has been input in the process registration mode is displayed. Therefore, compared to a case where the image forming apparatus 1 does not have the process edit mode, the burden of the user to search again for the setting screen 114 to which a change instruction has been input from among the plural setting screens 114 may be reduced.

FIG. 17 is a flowchart illustrating a process in which copying is performed on the basis of process registration data. Scan and output are performed during copying. The process illustrated in FIG. 17 is started by pressing the start button 1152 illustrated in FIG. 8B by the user. In step Sc1, the CPU 1011 reads out the initial values of the variables regarding the conditions of scan and output from the memory 103 and stores the initial values in the RAM 1013. In step Sc2, the CPU 1011 generates process condition data. The process condition data is based on process registration data and serves as conditions of output. The CPU 1011 reads out a piece of process registration data selected by the user from among the pieces of process registration data stored in the memory 103, and generates process condition data.

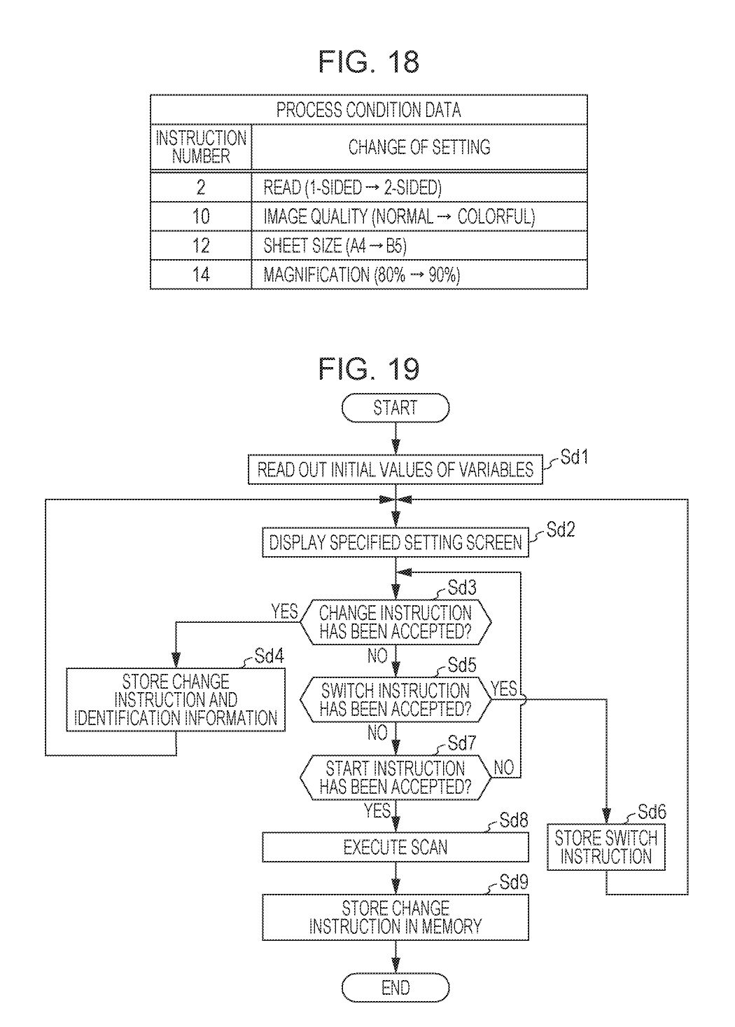

FIG. 18 is a diagram illustrating an example of process condition data. “Instruction number” and “change of setting” in the process condition data correspond to “instruction number” and “change of setting” in the process registration data. The process condition data is generated by performing, by the CPU 1011, the above-described processes (A) and (B) and the following process on the process registration data.

(G) In a case where a change instruction has been input plural times for the same variable and where the variable is not initialized by the last change instruction, a row other than the row corresponding to the largest instruction number among the rows for the change instructions for the variable is deleted.

The process condition data illustrated in FIG. 18 is generated on the basis of the process registration data illustrated in FIG. 16. When the process (A) is performed on the process registration data illustrated in FIG. 16, the rows corresponding to the instruction numbers “1”, “4”, “5”, “7”, and “9” are deleted. When the process (B) is performed, the rows corresponding to the instruction numbers “3”, “6”, “8”, and “13” are deleted. When the process (G) is performed, the row corresponding to the instruction number “11” is deleted.

Referring back to FIG. 17, in step Sc3, the CPU 1011 stores the process condition data in the RAM 1013. In step Sc4, the CPU 1011 executes scan and output on the basis of the process condition data and the initial values of the variables stored in the RAM 1013. Specifically, the CPU 1011 executes scan and output in accordance with the values of variables if the variables are included in the process condition data, and in accordance with the initial values of variables if the variables are not included in the process condition data.

The present invention is not limited to the above-described exemplary embodiment, and various exemplary modifications are acceptable. Hereinafter, some exemplary modifications will be described. Two or more of the following exemplary modifications may be used in combination.

### First Exemplary Modification

Process registration data is not necessarily generated in the process registration mode. For example, a change instruction may be input when the user provides an instruction to execute various functions of the image forming apparatus 1, and process registration data may be generated on the basis of the change instruction. In this case, the image forming apparatus 1 executes the various functions without using process registration data.

FIG. 19 is a flowchart illustrating a process which is the assumption of generation of process registration data according to a first exemplary modification. In the process illustrated in FIG. 19, scan is performed without process registration data being generated. The process illustrated in FIG. 19 is started upon an instruction to execute various functions being input by a user to the image forming apparatus 1. An instruction to start various functions is provided by, for example, operating a key provided in the input unit 105 or operating a button displayed on the display 104. Upon the instruction to start the various functions being input, the CPU 1011 displays a menu screen on the display 104.

In step Sd1, the CPU 1011 reads out the initial values of the variables regarding the conditions of scan and output from the memory 103, and stores the initial values in the RAM 1013. In step Sd2, the CPU 1011 displays a setting screen specified by a switch instruction on the display 104. The process performed in step Sd2 is similar to the process performed in step Sa1 in the process registration mode. In step Sd3, the CPU 1011 determines whether or not input of a change instruction has been accepted. If it is determined that input of a change instruction has been accepted (YES in step Sd3), the CPU 1011 proceeds to step Sd4. If it is determined that input of a change instruction has not been accepted (NO in step Sd3), the CPU 1011 proceeds to step Sd5.

In step Sd4, the CPU 1011 stores the change instruction in the RAM 1013 together with identification information. The CPU 1011 writes the change instruction in the RAM 1013 together with the identification information about the setting screen 114 displayed on the display 104. In step Sd5, the CPU 1011 determines whether or not input of a switch instruction has been accepted. If it is determined that input of a switch instruction has been accepted (YES in step Sd5), the CPU 1011 proceeds to step Sd6. If it is determined that input of a switch instruction has not been accepted (NO in step Sd5), the CPU 1011 proceeds to step Sd7.

In step Sd6, the CPU 1011 performs the process corresponding to step Sa6 in the process registration mode. In step Sd7, the CPU 1011 determines whether or not input of a start instruction has been accepted. The start instruction is an instruction to execute a function selected by the user from among the various functions. The start instruction is input by, for example, pressing a start button provided in the input unit 105 by the user. Alternatively, the start button may be displayed on the display 104. If it is determined that input of a start instruction has been accepted (YES in step Sd7), the CPU 1011 proceeds to step Sd8. If it is determined that input of a start instruction has not been accepted (NO in step Sd7), the CPU 1011 returns to step Sd3.

In step Sd8, the CPU 1011 executes scan on the basis of the change instruction and the initial values of the variables stored in the RAM 1013. Specifically, the CPU 1011 executes scan in accordance with the values of variables if the variables are indicated by change instructions, and in accordance with the initial values of variables if the variables are not indicated by change instructions. In step Sd9, the CPU 1011 writes the change instructions stored in the RAM 1013 in the memory 103.

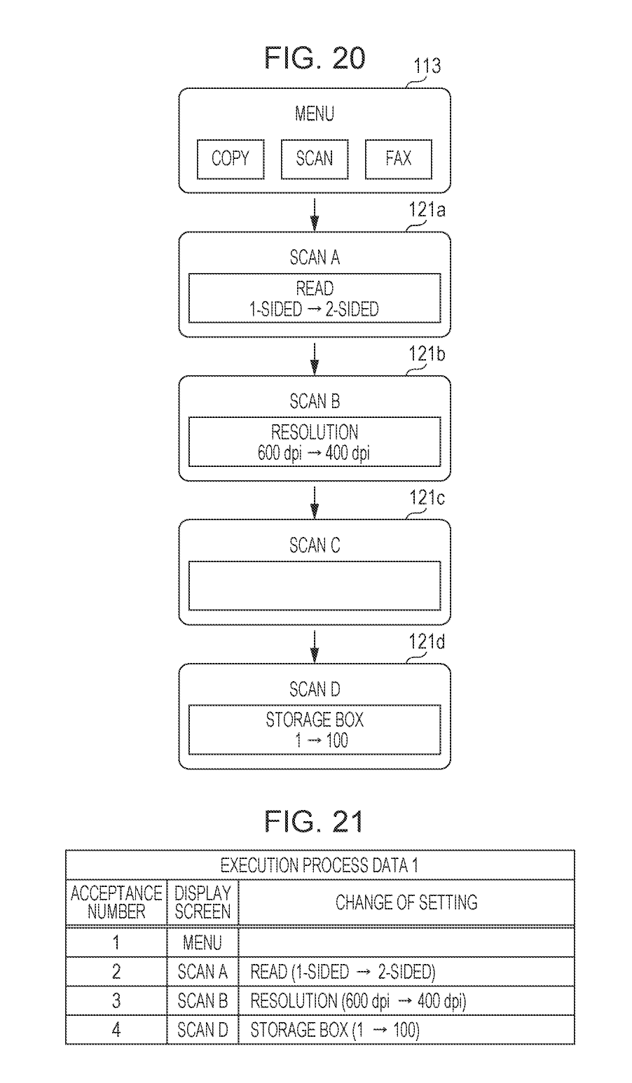

FIG. 20 is a diagram illustrating an example of switching a setting screen 121 in an image formation process. FIG. 20 illustrates, like FIG. 6, a state where the first display region in the setting screen 121 is switched. Upon the process registration mode being started, the menu screen 113 is displayed on the display 104. FIG. 20 illustrates an example in which the user selects “scan” as a function for which a change of the value of a variable is to be registered. When the user selects “scan” on the menu screen 113, the identification information “scan A” is stored in the RAM 1013. As a result, a setting screen 121a identified by the identification information “scan A” is displayed on the display 104.

In the example illustrated in FIG. 20, the setting screen 121 is switched from the setting screen 121a to a setting screen 121d in the order indicated by arrows in accordance with operations performed by the user. On the setting screens 121a, 121b, and 121d among the setting screens 121a to 121d, the user inputs a change instruction before inputting a switch instruction. On the other hand, on the setting screen 121c, the user inputs a switch instruction without inputting a change instruction.

On the setting screen 121a, the user inputs a change instruction to change the value of the variable indicating the setting of reading from “1-sided” to “2-sided”. On the setting screen 121b, the user inputs a change instruction to change the value of the variable indicating the setting of resolution from “600 dpi” to “400 dpi”. On the setting screen 121d, the user input a change instruction to change the value of the variable indicating the setting of a storage box from “1” to “100”. The value of the storage box represents the region in which scanned data is stored.

FIG. 21 is a diagram illustrating an example of data indicating the change instructions which have been written in the memory 103 in the process illustrated in FIG. 19 (hereinafter referred to as execution process data). FIG. 21 illustrates execution process data in a case where change instructions and switch instructions are input in the order illustrated in FIG. 20. “Acceptance number” is a number for identifying a change instruction accepted by the CPU 1011. “Display screen” and “change of setting” in the execution process data correspond to “display screen” and “change of setting” in the process registration data. In the execution process data, the identification information about the menu screen 113 is stored in the column “display screen” in the row corresponding to the acceptance number “1”. As described above, the user inputs change instructions on the setting screens 121a, 121b, and 121d. Thus, in the rows corresponding to the acceptance numbers “2”, “3”, and “4”, the content of a change instruction is stored in the column “change of setting”. On the other hand, the user does not input a change instruction on the menu screen 113 and the setting screen 121c. Thus, in the row corresponding to the acceptance number “1”, the content of a change instruction is not stored in the column “change of setting”. Also, the execution process data illustrated in FIG. 21 does not include a row indicating the identification information about scan C.

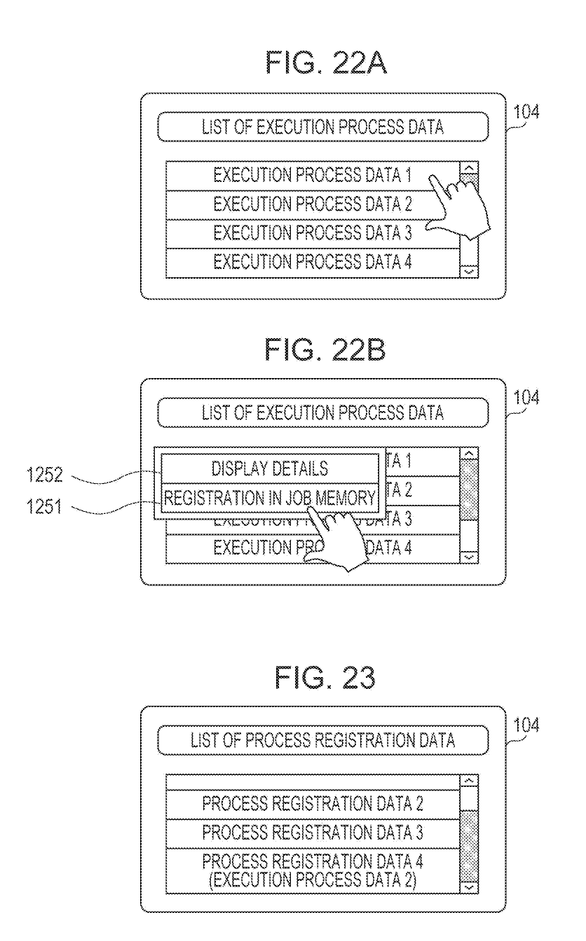

FIGS. 22A and 22B are diagrams illustrating an example in which the user generates process registration data on the basis of execution process data. To generate process registration data, the user operates the display 104 to display a list of execution process data. The list of execution process data is a list of execution process data which has been written in the memory 103. In FIG. 22A, the list of execution process data includes “execution process data 1” to “execution process data 4”, and the user selects “execution process data 2”. When the user selects a piece of execution process data from among the pieces of execution process data included in the list, the CPU 1011 displays a registration button 1251 and a display details button 1252 on the display 104, as illustrated in FIG. 22B. The registration button 1251 is a button for registering execution process data as process registration data. The display details button 1252 is a button for displaying the content of execution process data. In the first exemplary modification, process registration data is generated by pressing the registration button 1251 by the user. Upon pressing of the display details button 1252, the content of the execution process data illustrated in FIG. 21 is displayed on the display 104.

FIG. 23 is a diagram illustrating an example of process registration data generated on the basis of execution process data. In the example illustrated in FIG. 23, “process registration data 4” is newly generated on the basis of “execution process data 2”, and is displayed in the list of process registration data. The process registration data is generated by replacing “acceptance number” of execution process data with “instruction number”. The value indicated by “acceptance number” of execution process data is regarded as the value of “instruction number”.

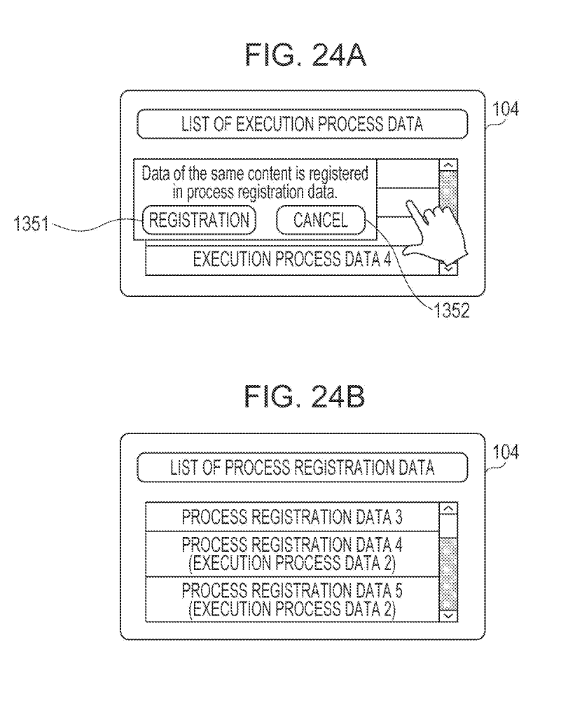

FIGS. 24A and 24B are diagrams illustrating another example in which the user generates process registration data on the basis of execution process data. In this example, the user generates “process registration data 4” on the basis of “execution process data 2” and then tries to generate process registration data on the basis of “execution process data 2” again. In this case, as illustrated in FIG. 24A, a message, a registration button 1351, and a cancel button 1352 are displayed on the display 104. The message indicates that the process registration data of the same content as the execution process data selected by the user is registered. If the user presses the registration button 1351, process registration data having the same content as the already registered process registration data is newly generated. If the user presses the cancel button 1352, generation of process registration data is cancelled. In FIG. 24B, “process registration data 5” is newly generated on the basis of “execution process data 2”.

### Second Exemplary Modification

The display scheme used for the corresponding images 117 in the process edit mode is not limited to the above-described cover flow scheme. The corresponding images 117 may be displayed using any scheme as long as they are included in the corresponding screen 116. For example, the corresponding images 117 may be displayed in the form of thumbnails.

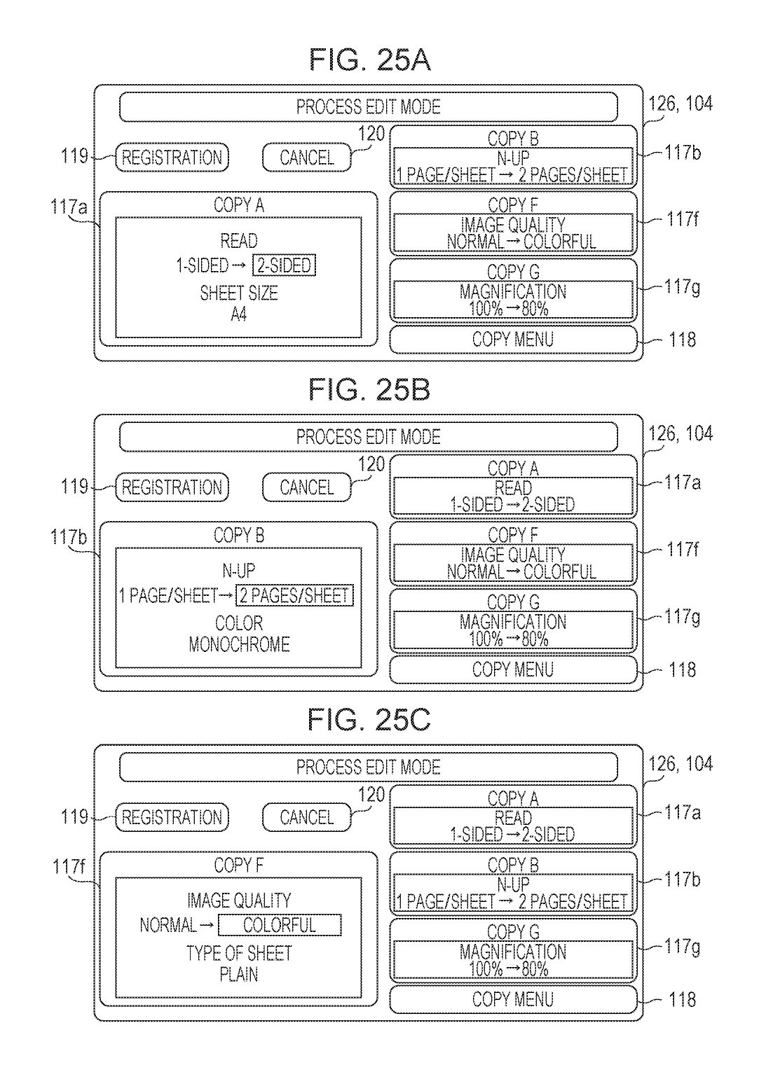

FIGS. 25A to 25C are diagrams illustrating corresponding screens 126 according to a second exemplary modification. The corresponding screens 126 illustrated in FIGS. 25A to 25C are different from the corresponding screens 116 illustrated in FIGS. 11A to 11C in that the corresponding images 117 are displayed in the form of thumbnails. In the examples illustrated in FIGS. 25A to 25C, target images are corresponding images 117a, 117b, and 117f, respectively. The target image is switched by touching a corresponding image 117 other than the target image by the user. For example, if the user touches the corresponding image 117b in the state illustrated in FIG. 25A, the target image is switched from the corresponding image 117a to the corresponding image 117b. In FIGS. 25A to 25C, as in FIGS. 11A to 11C, the variable whose value has been changed in response to a change instruction in the process registration mode is displayed so as to be distinguished from the other variables whose value has not been changed in response to a change instruction.

### Third Exemplary Modification

Regarding display of the corresponding images 117, the method for displaying the variable whose value has been changed in response to a change instruction in the process registration mode so as to be distinguished from the other variables whose value has not been changed in response to a change instruction is not limited to the method of surrounding the value by a rectangle. The variable whose value has been changed in response to a change instruction may be displayed in a different color from that of the other variables whose value has not been changed in response to a change instruction. Alternatively, the variable whose value has been changed in response to a change instruction may be displayed in a different font from that of the other variables whose value not been changed in response to a change instruction. Alternatively, the variable whose value has been changed in response to a change instruction may be displayed in a larger size than that of the other variables whose value has not been changed in response to a change instruction.

### Fourth Exemplary Modification

The processes according to an exemplary embodiment of the present invention are not limited to the processes described in the flowcharts. For example, in the process edit mode, the CPU 1011 may display a corresponding screen without generating process edit data. In this case, the process in steps Sb1 and Sb2 is not performed, and the CPU 1011 displays a corresponding screen on the basis of process registration data. In a case where a corresponding screen is displayed without process edit data being generated, the corresponding screen includes the corresponding images 117 corresponding to the setting screens 114 which have been displayed on the display 104 and to which a change instruction has not been input. For example, in a case where the corresponding screen 116 is displayed on the basis of the process registration data illustrated in FIG. 7, the corresponding screen 116 includes the corresponding images 117d and 117e corresponding to the setting screens 114d and 114e. Also, in a case where the corresponding screen 116 is displayed without process edit data being generated, the corresponding screen 116 includes the corresponding image 117 corresponding to the setting screen 114 to which a change instruction to initialize the value of a variable is input. For example, in a case where the corresponding screen 116 is displayed on the basis of the process registration data illustrated in FIG. 7, the corresponding screen 116 includes the corresponding image 117c corresponding to the setting screen 114c. The variable for which a change instruction to initialize the value has been input may be displayed so as to be distinguished from the other variables which have not been changed in response to a change instruction.

### Fifth Exemplary Modification

The process for generating process edit data from process registration data by the CPU 1011 is not limited to the above-described processes (A) and (B). The CPU 1011 may generate process edit data by performing, for example, the following processes.

(H) In process registration data, the rows in which a change instruction is stored in the column “change of setting” are written in the RAM 1013 in ascending order of the instruction number.

(I) In the process (H), if a change instruction for the same variable has already been written in the RAM 1013, the row of the change instruction is overwritten.

When the processes (H) and (I) are performed on the process registration data illustrated in FIG. 7, the rows corresponding to the instruction numbers “2”, “3”, “6”, “8”, “10”, and “11” are written in the RAM 1013. The row corresponding to the instruction number “6” is overwritten with the row corresponding to the instruction number “8”. In a case where process edit data is generated through the processes (H) and (I), the corresponding screen 116 includes the corresponding image 117 corresponding to the setting screen 114 to which a change instruction to initialize the value of a variable has been input.

Alternatively, either of the above-described processes (A) and (B) may be omitted. In a case where the process (A) is omitted, the corresponding screen 116 includes the corresponding images 117 corresponding to the setting screens 114 which have been displayed on the display 104 and to which a change instruction has not been input. In a case where the process (B) is omitted, the corresponding screen 116 includes the corresponding images 117 corresponding to the setting screens 114 to which a change instruction to initialize the value of a variable has been input.

### Sixth Exemplary Modification

The information processing apparatus in which the processes according to an exemplary embodiment of the present invention are performed is not limited to the image forming apparatus 1. The information processing apparatus may be any apparatus as long as the apparatus performs a specific process in accordance with the values of variables stored in the memory 103 or the RAM 1013.

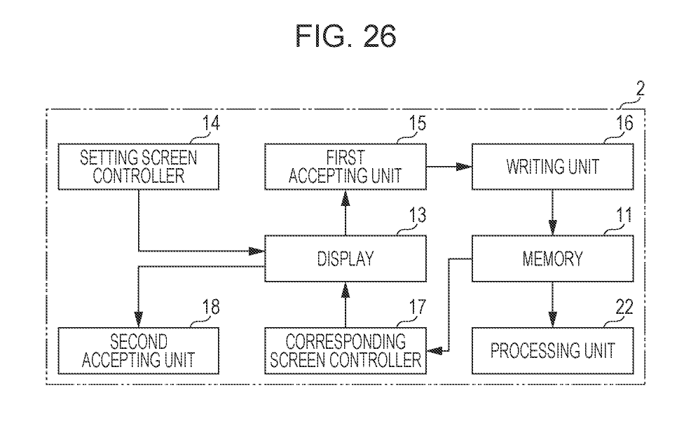

FIG. 26 is a block diagram illustrating a functional configuration of an information processing apparatus 2 according to a sixth exemplary modification. In FIG. 26, the information processing apparatus 2 includes a processing unit 22 instead of the image forming unit 12 illustrated in FIG. 1. The processing unit 22 performs a specific process in accordance with the values of plural variables stored in the memory 11.

### Seventh Exemplary Modification

A control program executed by the image forming apparatus 1 according to the exemplary embodiment may be provided by being stored in a computer-readable recording medium, such as a magnetic recording medium (magnetic tape, magnetic disk (hard disk drive (HDD), flexible disk (FD)), etc.); an optical recording medium (optical disk (compact disk (CD), digital versatile disk (DVD)), etc.); a magneto-optical recording medium; and a semiconductor memory (flash ROM, etc.). Alternatively, the control program may be downloaded via a network, such as the Internet.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first display controller that causes a display to display a setting screen in accordance with an operation performed by a user, the setting screen allowing the user to set a value of a variable in setting information regarding processing of the information processing apparatus;
a first accepting unit that accepts, while the setting screen is being displayed on the display, a change instruction to change the value of the variable included in the setting screen;
a memory that stores information on the change instruction accepted by the first accepting unit in the order in which the value is changed, in association with identification information;
a second display controller that, in response to accepting the identification information from the user, causes the display to display a screen which includes an image of the setting screen which corresponds to the accepted identification information; and
a second accepting unit that accepts, while the corresponding setting screen is being displayed on the display, a change instruction to change a value of a variable included in the corresponding setting screen.

2. The information processing apparatus according to claim 1,
wherein the second display controller causes the display to display, based on the information stored in the memory, a variable whose value has been changed by the user in response to the change instruction among variables included in the corresponding setting screen, so as to be distinguished from the other variables whose value has not been changed in response to the change instruction.

3. The information processing apparatus according to claim 1,
wherein in a case where the change instruction is provided for a plurality of setting screens, the second display controller causes the display to display a screen which does not include an image of a setting screen which does not include a variable whose value has been changed in response to the change instruction.

4. The information processing apparatus according to claim 3,
wherein the memory also stores an initial value of the value of the variable, and
wherein, in a case where in the change instruction a value of a first variable is changed from an initial value, and is changed to the initial value again, the second display controller determines that the value of the first variable has not been changed.

5. The information processing apparatus according to claim 1, wherein
in a case where the change instruction is provided for a first, a second, and a third setting screens, and
in a case where changing a value in the second setting screen is performed after changing a value in the first setting screen, and changing a value in the third setting screen is performed after changing the value in the second setting screen,
the second display controller controls the display to display a screen which includes an image of the first, the second, and the third setting screens, and a size of the image of the first and the third setting screens is smaller than a size of the image of the second setting screen.

6. The information processing apparatus according to claim 1,
wherein the second display controller causes the display to display a screen including a thumbnail of an image of the setting screen.

7. The information processing apparatus according to claim 1,
wherein the memory includes a first memory region and a second memory region which is different from the first memory region,
wherein information on the change instruction accepted by the first accepting unit and the identification information are stored in the first memory region,
wherein the variable having a value which has been changed in response to the change instruction is stored in the second memory region, and
wherein the processing of the information processing apparatus is performed in accordance with the value of the variable stored in the second memory region.

8. An image forming apparatus comprising:
an image forming unit that forms an image on a recording medium;
a first display controller that causes a display to display a setting screen in accordance with an operation performed by a user, the setting screen allowing the user to set a value of a variable in setting information regarding processing of the information processing apparatus;
a first accepting unit that accepts, while the setting screen is being displayed on the display, a change instruction to change the value of the variable included in the setting screen;
a memory that stores information on the change instruction accepted by the first accepting unit in the order in which the value is changed, in association with identification information;
a second display controller that, in response to accepting the identification information from the user, causes the display to display a screen which includes an image of the setting screen which corresponds to the accepted identification information; and
a second accepting unit that accepts, while the corresponding setting screen is being displayed on the display, a change instruction to change a value of a variable included in the corresponding setting screen.

9. An information processing method comprising:
causing a display to display a setting screen in accordance with an operation performed by a user, the setting screen allowing the user to set a value of a variable in setting information regarding processing of an information processing apparatus;
accepting, while the setting screen is being displayed on the display, a change instruction to change the value of the variable included in the setting screen;
storing information on the accepted change instruction in the order in which the value is changed, in association with identification information;
in response to accepting the identification information from the user, causing the display to display a screen which includes an image of the setting screen which corresponds to the accepted identification information; and
accepting, while the corresponding setting screen is being displayed on the display, a change instruction to change a value of a variable included in the corresponding setting screen.

10. A non-transitory computer readable medium storing a program causing a computer to execute a process, the process comprising:
causing a display to display a setting screen in accordance with an operation performed by a user, the setting screen allowing the user to set a value of a variable in setting information regarding processing of an information processing apparatus;
accepting, while the setting screen is being displayed on the display, a change instruction to change the value of the variable included in the setting screen;
storing information on the accepted change instruction in the order in which the value is changed, in association with identification information;
in response to accepting the identification information from the user, causing the display to display a screen which includes an image of the setting screen which corresponds to the accepted identification information; and
accepting, while the corresponding setting screen is being displayed on the display, a change instruction to change a value of a variable included in the corresponding setting screen.
